(19) United States
(12) Patent Application Publication
(10) Pub. No.: US 2019/0042579 A1
(43) Pub. Date: Feb. 7, 2019

(54) A Data Acquisition and Communication System

(71) Applicant: Clap Online Pty Ltd, Stanwell Park, NSW (AU)

(72) Inventors: Paul Joshua Bedwell, Stanwell Park, NSW (AU); MaryJane Sharon Bulseco, Bronte, NSW (AU); Stanislav Tsvirko, Peakhurst, NSW (AU)

(21) Appl. No.: 16/076,317

(22) PCT Filed: Feb. 8, 2017
(86) PCT No.: PCT/AU2017/000037

§ 371 Date: Aug. 7, 2018

Related U.S. Application Data
(60) Provisional application No. 62/293,740, filed on Feb. 10, 2016.

(51) Int. Cl. G06F 17/30; H04L 29/08; G06Q 50/00

(52) U.S. Cl. CPC G06F 17/3053; H04L 67/22; G06F 17/30867; G06Q 50/01; G06F 17/30038; G06F 17/30554; H04L 67/306

(57) ABSTRACT

A computer implemented method of communicating, between computers belonging to a first group communicating over a communication network using a server executing a software application, tagged content items and scores, the method comprising: receiving (608) by the first server a tagging indication from a first computer, the tagging indication indicating that the first computer has tagged a content item that is accessible over the communication network; determining (925), by the first server, a score for the content item dependent upon a number of times the content item is tagged by other computers belonging to the first group; repeating (922) by the first server the receiving and determining steps for a plurality of content items that are tagged by computers belonging to the first group; and arranging (905) by the first server, depending upon the determined scores, the plurality of content items and their associated scores in a first list that is accessible by the first group of computers.

### TECHNICAL FIELD

The present invention relates generally to communication systems and, in particular, to communication systems which interoperate with social networks.

### BACKGROUND

Social networks enable users to communicate with each other by posting messages, images, comments and the like using dedicated social network software such as Facebook®, LinkedIn®, Twitter® and others. Although social networks are experiencing dramatic growth both in user numbers and capabilities, they are still limited in the type of information which is gathered and shared.

### SUMMARY

It is an object of the present invention to substantially overcome, or at least ameliorate, one or more disadvantages of existing arrangements.

Disclosed are arrangements, referred to as Aggregating Ranking Display and Dissemination (ARDD) arrangements, which seek to address the above problems by aggregating tagged content from a plurality of social networks and other sources, sharing the tagged content across multiple social networks, and displaying the tagged content in a variety of dynamic feeds.

According to a first aspect of the present disclosure, there is provided a computer implemented method of communicating, between computers in a first group of computers communicating over a communication network using a first server computer executing a first social network software application, tagged content items and scores determined for the tagged content items, the method comprising the steps of: receiving by the first server a tagging indication from a first computer belonging to the first group, the tagging indication indicating that the first computer has tagged a content item that is accessible over the communication network; determining, by the first server, a score for the content item dependent upon a number of times the content item is tagged by other computers belonging to the first group; repeating by the first server the receiving and determining steps for a plurality of content items that are tagged by computers belonging to the first group; and arranging by the first server, depending upon the determined scores, the plurality of content items and their associated scores in a first list that is accessible by the first group of computers.

According to another aspect of the present disclosure, there is provided an apparatus for implementing any one of the aforementioned methods.

According to another aspect of the present disclosure there is provided a computer program product including a computer readable medium having recorded thereon a computer program for implementing any one of the methods described above.

Other aspects are also disclosed.

### BRIEF DESCRIPTION OF THE DRAWINGS

At least one embodiment of the present invention will now be described with reference to the drawings, in which:

FIGS. 1A-1B form a schematic block diagram of a general purpose computer system upon which ARDD arrangements described can be practiced;

FIG. 2 shows functional block diagram of how the disclosed ARDD arrangement can be implemented;

FIG. 3 illustrates one example of how the disclosed ARDD arrangement operates, for users who are members of both the ARDD arrangement and another social network;

FIG. 4 illustrates another example similar to that shown in FIG. 3;

FIGS. 5A-5B illustrate registration and login processes for the ARDD arrangement;

FIG. 6 shows a content navigation and tagging process for a ARDD arrangement;

FIG. 7 shows how tagged content is directed feeds in the ARDD arrangement;

FIG. 8 shows how content is ranked and displayed in the ARDD network, shared with other linked social networks, and received from other linked social networks in a ARDD arrangement;

FIGS. 9A-9C show how tagged content is buffered, aged, and scored in the ARDD arrangement;

FIGS. 10A-10C show how tagged content is filtered, ranked and displayed in various feeds in a ARDD arrangement;

FIG. 11 is a flowchart for an example ARDD process performed by a mobile device in the ARDD arrangement.

FIGS. 12A and 12B depict GUIs in a ARDD arrangement for registration and linking to other social networks;

FIGS. 13A and 13B depict a pending feed (also referred to as a “keeps” feed) and a scrolling feed in the ARDD arrangement;

FIG. 14 illustrates a Clap button in a GUI in another network that is linked to the ARDD network;

FIG. 15 illustrates a “Best” feed display in a ARDD arrangement; and

FIG. 16 illustrates a “Friends” feed display in a ARDD arrangement;

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which may form public knowledge through their use. Such discussions should not be interpreted as a representation by the present inventor(s) or the patent applicant that such devices in any way form part of the common general knowledge in the art.

The ARDD arrangement, also referred to as the ARDD network, aims to display, for ARDD network members, Internet content that has been tagged as being popular by ARDD network members. The ARDD arrangement also allows ARDD network users post their own content and have it processed and displayed in the same manner.

More particularly, the ARDD arrangement processes and displays “most popular” content from a number of sources including content accessible over the Internet, content that is accessible from within many or all social media platforms, and content that is accessible within an ARDD network member's smart phone. In operation, a ARDD network member “tags” (“tagging is also referred to as “clapping” to show approbation) content, which is consequently posted to one or more feeds that are accessible in the ARDD network. A feed is a display format, such as an ordered list, which provides viewers with frequently updated content. Tagged content can also be posted to linked social media networks.

The tagged content has associated metadata including a link to an address at which the tagged content can be accessed. The feeds present content in an ordered manner, from highest ranked (ie most popular by virtue of having been tagged by the most ARDD network members) to least popular (by virtue of having been tagged by the least ARDD network members). The feeds are continually updated to reflect the most tagged content at the top of the feeds.

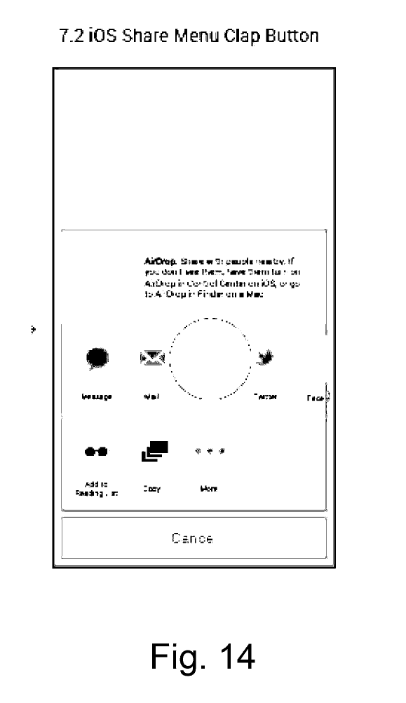

The ARDD arrangement enables a “Clap Button” to be installed in the Graphical User Interface (GUI) of compliant web browsers, as depicted in FIG. 14, as well as other mobile applications, including mobile applications from other social networks or photo albums or other mobile application types, making it easy for ARDD network members to “tag” (ie “Clap”) content. The ARDD arrangement also enables the clap button to be accessed from the iOS share menu, which allows content to be shared from multiple social media apps, such as BuzzFeed®, Reddit®, Flipboard® and others. In some ARDD arrangements, the clap button is available to be accessed in the background, or while running applications on mobile and web browsers, as a plug in or button operating on top of or behind an open browser, software application or web page.

The ARDD arrangement brings together a wide range of social media content in one place via the ARDD network, and also provides ARDD network members the ability to identify and tag the most engaging information found on the web and all the social networks.

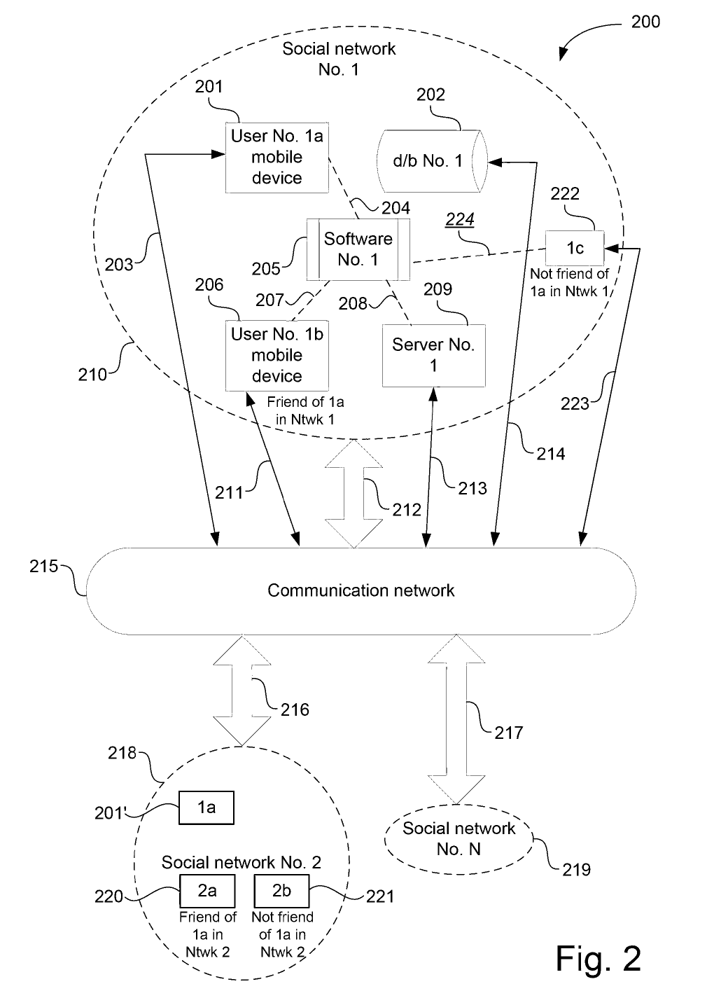

The ARDD arrangement, described hereinafter in more detail with regard to FIG. 2, can be implemented as a suite 205 of software applications including an ARDD server application 133 running on an ARDD server 209, and mobile software applications 225 executing on mobile devices 201 such as smart phones or tablets. The suite 205 is in some instances referred to as a first software application or alternately a first set of software application modules.

FIG. 2 shows functional block diagram of how the disclosed ARDD arrangement can be implemented. Depicted is an example 200 of three social networks having respective reference numerals 210, 218 and 219. These social networks enable their members (not shown) to interact over a communication network 215 as depicted by respective bidirectional arrows 212, 216 and 217. The social network 210, which embodies the ARDD arrangement and is also referred to as the ARDD network in one example, comprises a number of mobile devices 201, 206 and 222, which communicate over the communication network 215 as depicted by respective arrows 203, 211 and 223. The ARDD network 210 also comprises a server 209 running the ARDD server software application 133, and a database 202. The mobile devices 201, 206 and 222 are in some instances referred to as a first group of computers.

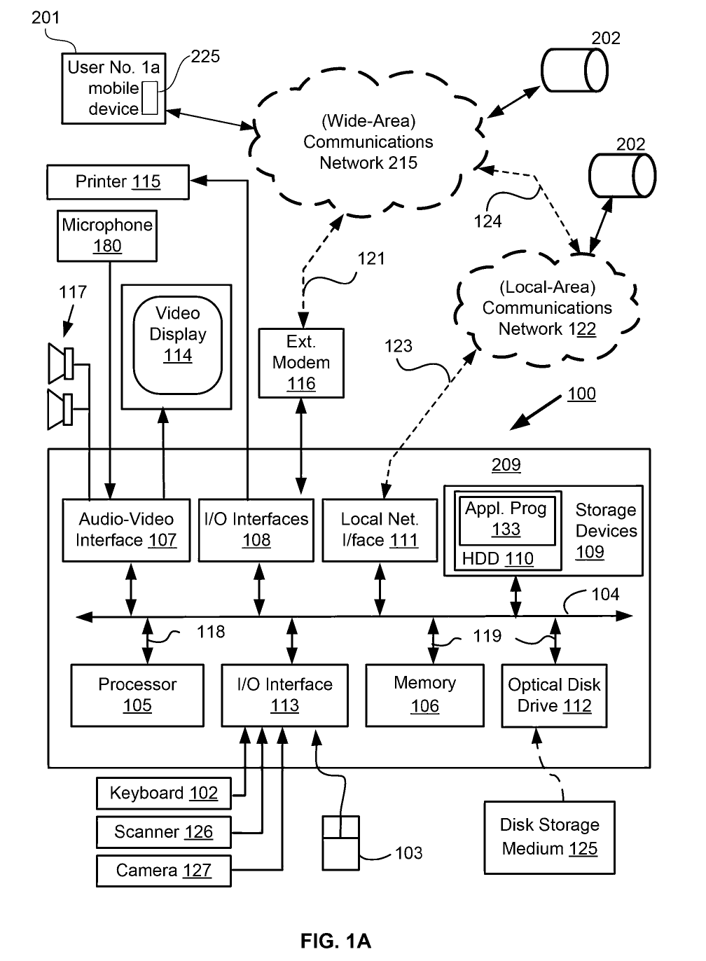

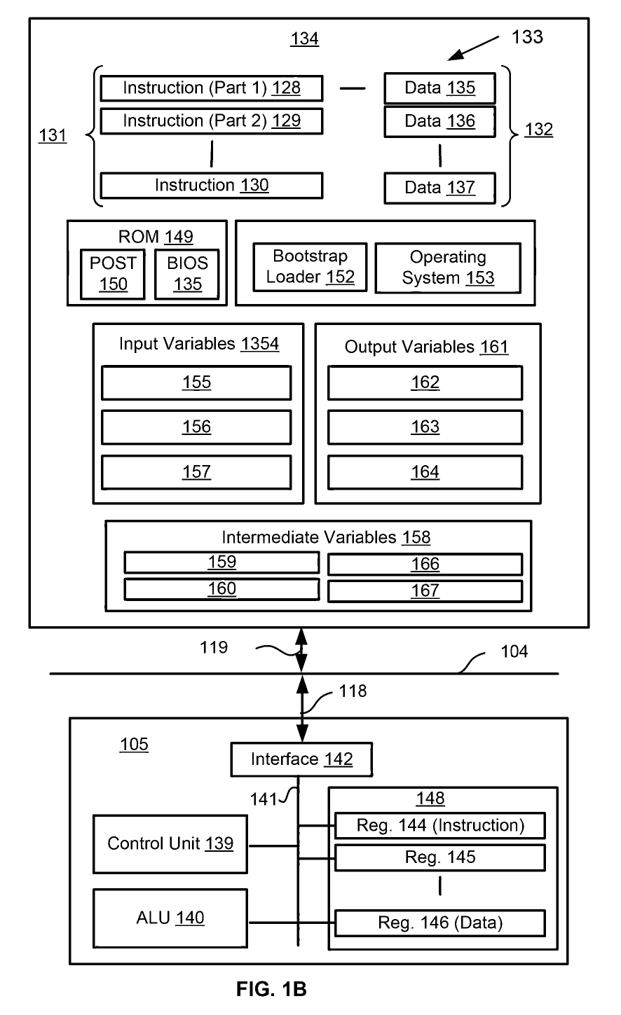

The mobile devices 201, 206 and 222 run software applications (such as 225 in FIG. 1A) which are computer executable software modules collectively depicted by the ARDD software suite 205, as depicted by dashed arrows 204, 207 and 224. The server 209 executes the ARDD server software application 133 (see FIG. 1A) which is part of the ARDD software suite 205, as depicted by a dashed arrow 208.

Each of the mobile devices 201, 206 and 222 are associated with a respective user (not shown). The user associated with the mobile device 201 is referred to as a “friend” of a user associated with the mobile device 206. FIG. 2 shows this association by labels indicating that the mobile device 206 (also referred to as the device 1b) is a “friend of 1a in FIG. 1”. This should be understood to mean that the users (not shown) of the mobile devices 201 and 206 are both members of the ARDD network 210, and that in the context of that network 210 they are friends. The mobile devices 201 and 206 whose respective users are “friends” in the context of the ARDD network 210, are in some instances referred to as a first sub-group in the first group of computers.

The users may become friends by number of different mechanisms. For example, one ARDD network user can send an invitation to another ARDD network user inviting them to become a friend (also referred to as a connection) and if the recipient of the invitation responds positively, then the ARDD server software 133 records the friendship in the database 202. In another example, the user (not shown) who is associated with the mobile device 201 can “follow” the user associated with the mobile device 206, and in a similar manner to the aforementioned example, the two users become friends (in the ARDD network), and this is recorded in the database 202. When a user chooses to highlight activity of another user, they are said to be “Following” that other user.

The user associated with the mobile device 222 is, as depicted by FIG. 2, not a friend of the user associated with the mobile device 201. This illustrates the fact that users of mobile devices in the ARDD network 210 can form sub-groups of friends, each of these sub-groups comprising some, but not other users associated with mobile devices in the ARDD network.

From the terminology the respective, henceforth the term “user” and the term “mobile device associated with the user” will be used interchangeably, and the meaning to be ascribed to the aforementioned terms will be established by context if not stated explicitly.

The mobile devices 201, 206 and 222 are also referred to as a “first group of computers”.

The mobile device 201 is also referred to as “User number 1a mobile device” as shown in FIG. 2, in order to show that the mobile device 201 is associated with user 1a (not shown) who is a member of the ARDD network 210. The user of the mobile device 201 is also a member of the social network 218 as depicted by a rectangle labelled 1a which has a reference numeral 201′. In other words, the user of the mobile device 201 is a member of both the ARDD network 210 and of the network 218.

The Social network No. 1 (i.e. 210) in the present description is referred to as the ARDD network (or alternatively as the “Clapit” network or the “Clapit” app, or simply as “Clapit”). The social network No. 2 (i.e. 218) may be the Facebook social network. The social network No. N (i.e. 219) may be the Twitter® network.

FIG. 2 is only one example of social networks, and the ARDD arrangement enables its members to interact with a wide variety of social networks over the communication network 215, including but not limited to Facebook®, Twitter®, LinkedIn®, Instagram®, and so on.

Returning to the network 218, as previously noted the mobile device 201′ is a member of both the network 218 and the ARDD network 210. A mobile device 220 has a user that is a member of the network 218, and furthermore the user of the mobile device 220 is a friend of the user of the mobile device 201′ in the network 218. A mobile device 221 has a user that is a member of the network 218, however the user of the mobile device 221 is nota friend of the user of the mobile device 201′.

FIGS. 1A and 1B depict a general-purpose computer system 100, upon which the various arrangements described can be practiced. A detailed description is provided in relation to the server 209. Similar descriptions are applicable to the user devices such as 201.

As seen in FIG. 1A, the computer system 100 includes: a computer module 209 (being the server 209 in FIG. 2); input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 209 for communicating to and from the mobile device 201, and/or one or more databases 202, over the communications network 215 via a connection 121. The communications network 215 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 215.

The computer module 209 typically includes at least one processor unit 105, and a memory unit 106. For example, the memory unit 106 may have semiconductor random access memory (RAM) and semiconductor read only memory (ROM). The computer module 209 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 209, for example within the interface 108. The computer module 209 also has a local network interface 111, which permits coupling of the computer system 100 via a connection 123 to a local-area communications network 122, known as a Local Area Network (LAN). As illustrated in FIG. 1A, the local communications network 122 may also couple to the wide network 215 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 209 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

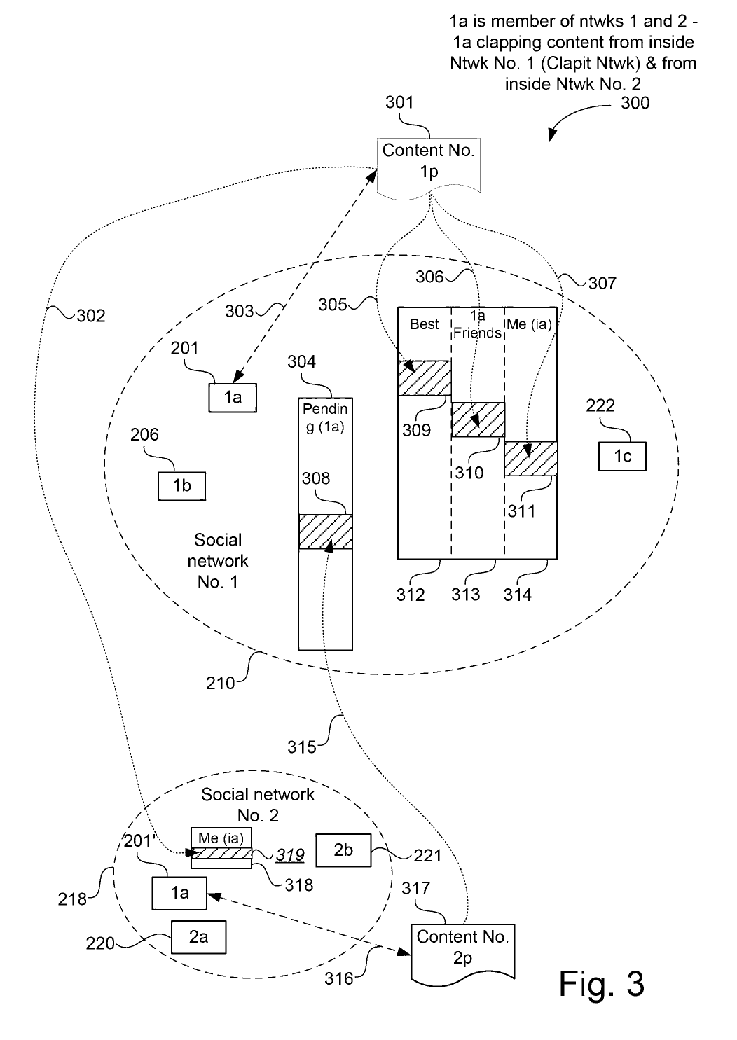

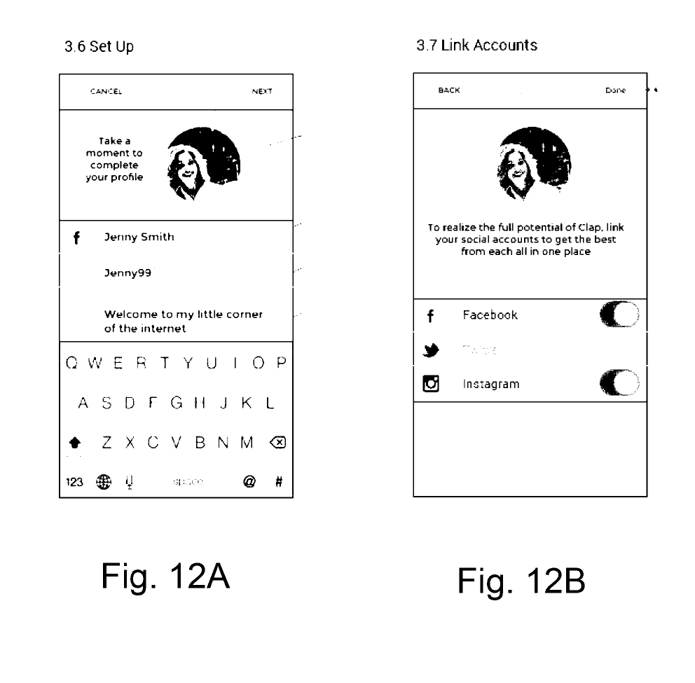

The ARDD methods may be implemented using the computer system 100 wherein the processes of FIGS. 3-11, to be described, may be implemented as one or more software application programs 133, 225 (or more generally 205) executable within the computer system 100. In particular, the steps of the ARDD methods are effected by instructions 131 (see FIG. 1B) in the software 133, 225 (or more generally 205) that are carried out within the computer system 100. The software instructions 131 may be formed as one or more code modules, each for performing one or more particular tasks. The software may also be divided into two separate parts, in which a first part and the corresponding code modules performs the ARDD methods and a second part and the corresponding code modules manage a user interface between the first part and the user (as illustrated in FIGS. 12-14).

The ARDD software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous ARDD apparatus.

The ARDD server software 133 is typically stored in the HDD 110 or the memory 106. The ARDD mobile software 225 is typically stored in a memory device (not shown) in the mobile device 201. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an ARDD apparatus.

In some instances, the application programs 133 (or more generally 205) may be supplied to the user encoded on one or more CD-ROMs 125 and read via the corresponding drive 112, or alternatively may be read by the user from the networks 215 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 209. Examples of transitory or non-tangible computer readable transmission media that may also participate in the provision of software, application programs, instructions and/or data to the computer module 209 include radio or infra-red transmission channels as well as a network connection to another computer or networked device, and the Internet or Intranets including e-mail transmissions and information recorded on Websites and the like.

The second part of the application programs 133 (or more generally 205) and the corresponding code modules mentioned above may be executed to implement one or more graphical user interfaces (GUIs) to be rendered or otherwise represented upon the display 114 and a display on the device 201. Through manipulation of typically the keyboard 102 at the server 209 and the mouse 103, and appropriate user interface on the device 201, a user of the computer system 100 and the ARDD application may manipulate the interfaces in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 209 in FIG. 1A.

When the computer module 209 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 209 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 209 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 215, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed ARDD arrangements use input variables 154, which are stored in the memory 134 in corresponding memory locations 155, 156, 157. The ARDD arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 3-11 is associated with one or more segments of the program 133 (or more generally 205) and is performed by the register section 144, 145, 147, the ALU 140, and the control unit 139 in the processor 105 working together to perform the fetch, decode, and execute cycles for every instruction in the instruction set for the noted segments of the program 133.

The ARDD method may alternatively be implemented in dedicated hardware such as one or more integrated circuits performing the ARDD functions or sub functions. Such dedicated hardware may include graphic processors, digital signal processors, or one or more microprocessors and associated memories.

FIG. 3 illustrates one example of how a ARDD arrangement can operate, for users who are members of both the ARDD network 210 and another social network 218. FIG. 3 relates to a situation in which the mobile device 201 is associated with a user who is a member of both the ARDD network 210 and the network 218, and in which the device 201 tags content from within the ARDD network 210, as well as from within the other network 218. The term “tagging from within a network” means that the user who is tagging a particular piece of content such as the content 301 is presently running the software application associated with the network in question. Thus, for example, the tagging operation depicted by the dashed line 303 is effected by the device 201 while it is running the software application 205 associated with the ARDD network 210 (ie this tagging operation is performed by the device 201 from within the ARDD network 210). In contrast, the tagging operation depicted by the dashed arrow 316 is performed by the device 210′ while that device 201′ is executing a software application (not shown) associated with the social network number 2 (i.e., 218) (ie this tagging operation is performed by the device 201 from within the network 218, in which event the device 201 is referred to by the reference numeral 201′).

FIG. 3 shows an example 300 of how the disclosed ARDD arrangements operate in regard to the ARDD network 210 and the distinct network 218. The user of the mobile device 201 has arrived at the item of content 301 (also referred to as content 1p). The device 201 can arrive at the content item 301 in a number of different ways, including by using a web browser (running on the device 201 but not shown in FIG. 3) over the Internet, or alternatively by navigating to an internal storage device within the device 201 in which the content item 301 has been previously stored. The device 201 (i.e. the user of the device) tags the content item 301, as depicted by a dashed arrow 303. The aforementioned “tagging” operation can also be referred to as a “Clap” operation.

The content item 301 has been chosen by the user in question because it was highly enjoyed by the user, thus prompting them to press the Clap button in order to tag the content item 301. To avoid an “Echo Chamber” effect across the ARDD network users, the ARDD arrangement may implement rules relating to tag operations 303, such as limits on maximum tag operations per 24-hour period. In addition the rules may also incorporate the prevention of the same content being moved into the feed more than once, since because users may have the same friends across multiple networks platforms, the tag broadcast (eg see 302 in FIG. 3) could put the same content into a feed multiple times without these rule.)

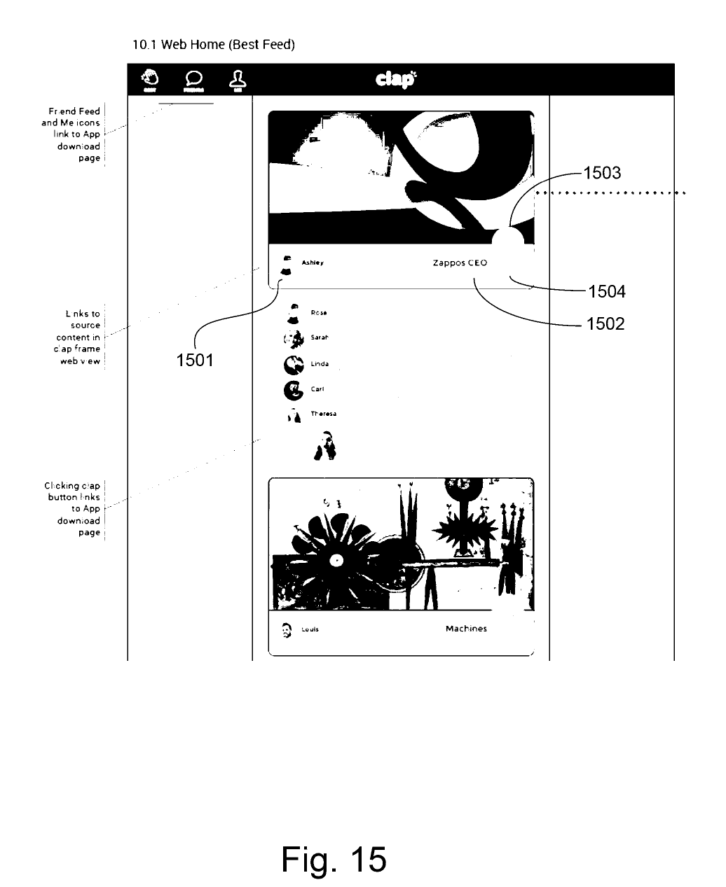

The effect of the aforementioned tagging operation 303 by the device 201 is as follows. The ARDD server 209 receives a tagging indication due to the tagging operation 303 and the content item 301 is inserted (ie “posted”) into a “Best” feed 312 as depicted by a dashed arrow 305. The “Best” feed 312, an example of which is illustrated in FIG. 15, can be implemented as a storage buffer in the memory 106 which stores a list of content items along with the associated meta-data such as the IP address at which the content item 301 may be found and the number of claps/user tags that the piece of content has attained. The ARDD server 209 determines a score for the content item 301 dependent upon the number of times the content item 301 is tagged by the other devices 206, 222, . . . in the ARDD network 210. In one ARDD arrangement each of the devices 201, 206, 222, . . . may only tag the content item 301 once, and accordingly the ARDD server only takes note of the first tagging operation by each device. Other scoring arrangements can, however, also be used. Other considerations for ranking content could include user reactions, sentiment tagged within these reactions, velocity of tags being added to content and content types.

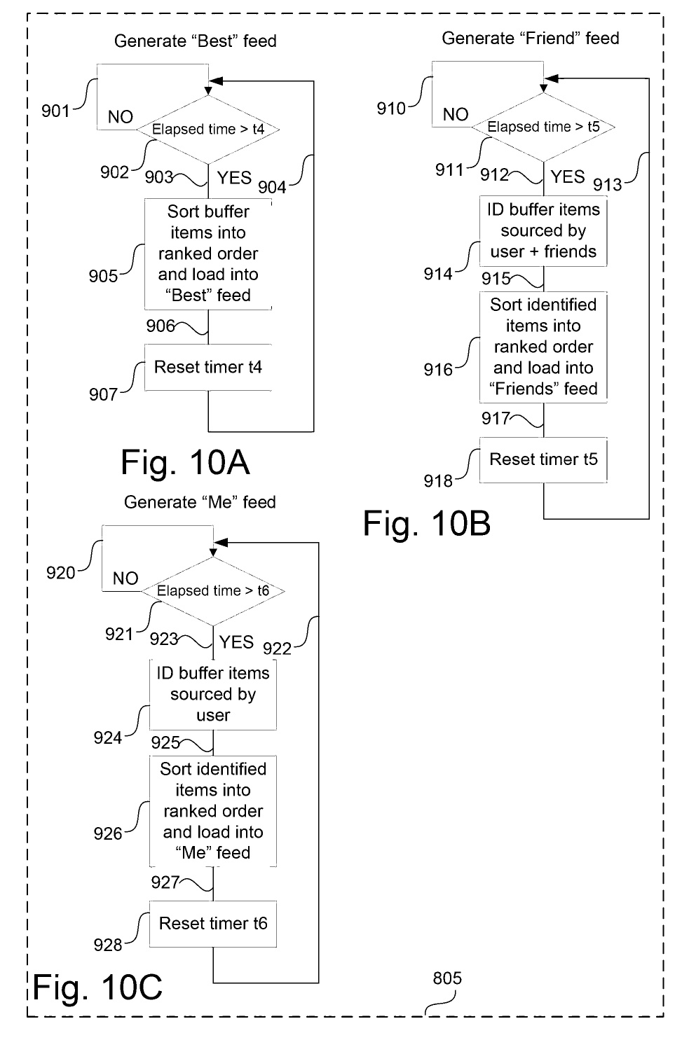

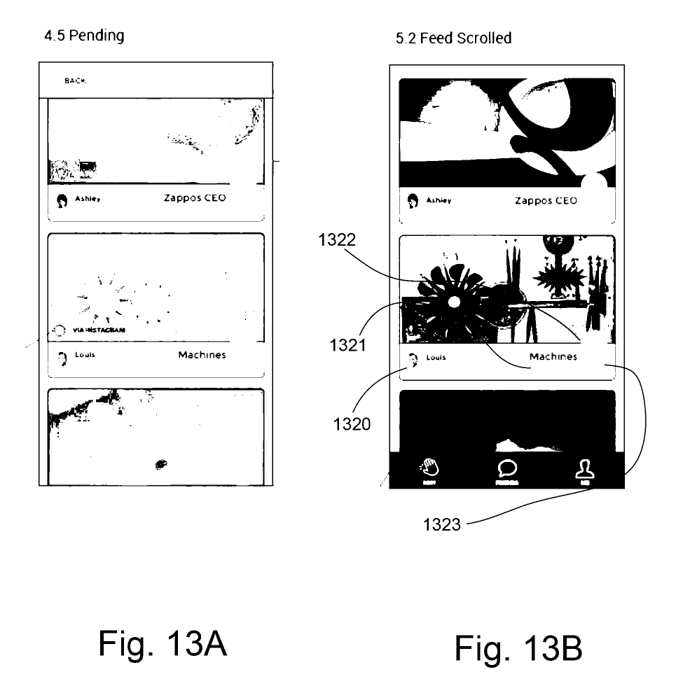

The “Best” feed contains tagged content items which dynamically move up the feed based on number of claps (ie tagging operations) they receive from ARDD network members. The “Best” feed ranks content items with the most claps highest on the feed, and refreshes hourly or at another desired rate (as described hereinafter in more detail with regard to FIG. 10A). The “Best” feed is, in one ARDD arrangement, a vertical scrolling feed, as depicted in FIG. 13B. The feed displays content items in a rectangle, using standard format for Articles (with headings taken from content H1, H2 tags), standard image format and standard video format (as illustrated in FIG. 15).

At the bottom left of each post (see 1501 in FIG. 15) a “reaction” picture of the first user to tag the content can be displayed. The reaction picture can sit in a frame that is the shape of a speech bubble. Next to the reaction picture a tally 1502 can be displayed showing the number of comments and reaction pictures associated with the content item. At the bottom right of each piece of content a Clap Icon 1503 can be displayed. This can colour coded according to the number of tag operations the content has received. Next to the icon 1503 a number 1504 reflecting the number of Claps the content has received can be displayed.

The ARDD server arranges the content items 309 in the “Best” feed 312 in accordance with the score associated with each of the content items 309. Thus, for example, if a particular content item has received a total of a hundred tag operations, then that item will be located higher up in the feed 312 than a content item that has only received 50 tag operations. The “Best” feed 312 is thus a dynamic list, in which the ARDD server continuously rearranges content items in the feed 312 so that the most popular content items (which have correspondingly greatest scores) are located higher up in the feed 312 than content items which are less popular. The ARDD server continuously rearranges the content items in the “best” feed 312 to reflect their popularity across the universe of users (i.e. members) in ARDD network 210.

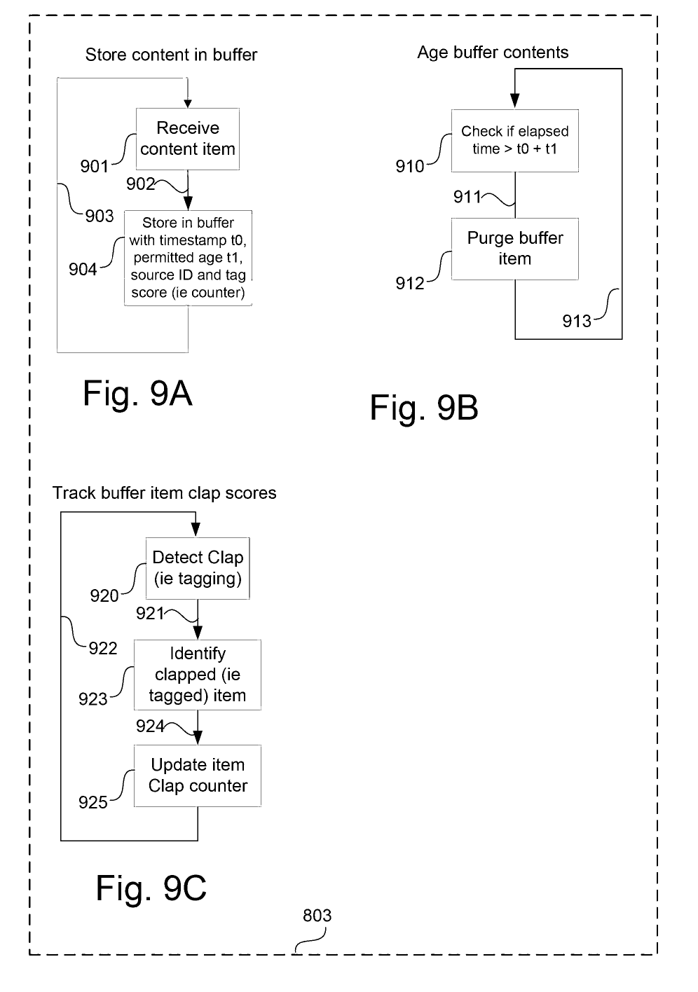

In one ARDD arrangement, described hereinafter in more detail with reference to FIG. 9B, content items are removed from the “Best” feed 312 (and the other feeds 313, 314) once a predefined time has elapsed since the last tagging operation relating to the content item in question. In another ARDD arrangement the scores that are assigned to each content item in the feed 312 are “aged”, meaning that the accumulated score for each content item is progressively reduced as time elapses, so that a more recent tagging operation has more weight than an older tagging operation. Alternately, content disappears from the feed after a period of time in which no activity in relation to the content has taken place (e.g. 5 hours)

The “Best” feed 312 is accessible by all of the devices 201, 206, 222, . . . in the ARDD network 210, these users being members of the ARDD network 210.

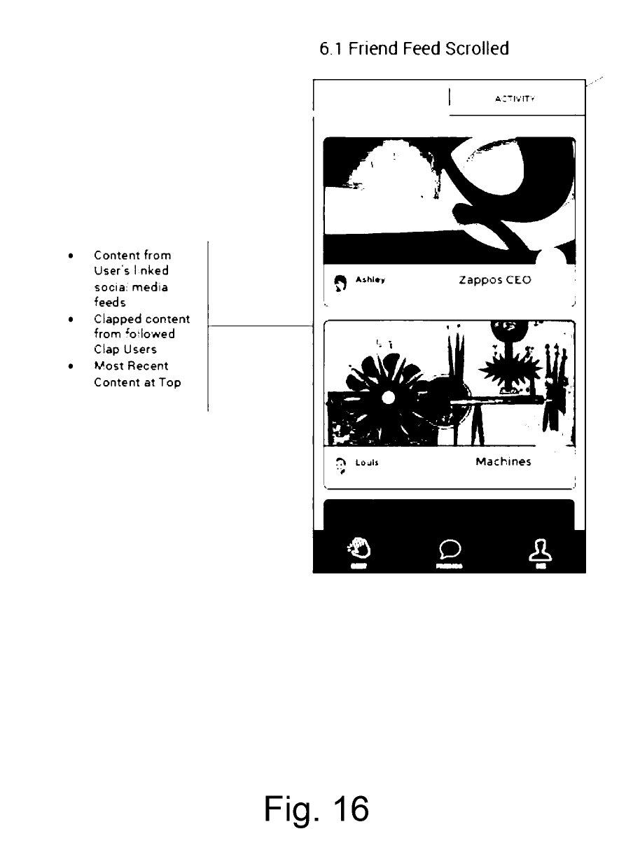

Another consequence of the tagging operation 303 is that the content item 301 is inserted, as depicted by a dotted arrow 306, into a “Friends” feed 313 (illustrated in FIG. 16), as depicted by a hashed rectangle 310. The “Friends” feed 313 is populated only by content items which are tagged by friends of the user of the device 201. Accordingly, the ARDD server 209 inserts the content item 301 into the “Friends” feed 313, as depicted by the hashed rectangle 310, and accumulates a score for the content item 310 depending upon how many times the content item 301 is tagged by users who are friends of the user of the device 201. The “Friends” feed 313 thus contains a list of content items, in order of their popularity in the same manner as the “Best” feed 312, however the content items in the “Friends” feed 313 are only those content items that have been tagged by friends of the user of the device 201.

The “Friends” feed for a particular user contains time-stamped content from all the user's linked social media feeds (described hereinafter in more detail with reference to 315 in FIG. 3), and also contains clapped content from all of their friends in the ARDD network. The “Friends” feed shows the most recent content at the top. In one ARDD arrangement, the “Friends” feed is a vertical scrolling feed.

It will be apparent, that there is only a single “Best” feed 312 in the network 210. It is further apparent that there are as many “Friends” feeds 313 as there are users in the ARDD network 210. The “Friends” feed 313 is designated as “1a” to indicate that the particular “Friends” feed 313 is associated with the device 1a (i.e. 201). There is another “Friends” feed (not shown) for the device 206, and yet another “Friends” feed (not shown) for the device 222.

When the device 201 tags (as depicted by the dashed arrow 303) the content item 301 a third consequence is that the content item 301 is inserted, as depicted by dotted arrow 307, into a “Me” feed 314 as depicted by a hashed rectangle 311. The “Me” feed 314 is also designated as “1a” to indicate that this is the “Me” feed 314 for the device 201. The ARDD server 209 inserts into the “Me” feed 314 only those content items that have been tagged at least by the device 201. Accordingly, each time the device 201 tags a content item, that item is inserted into the “Me” feed 314. The score of the item in the “Me” feed is dependent on upon how many times other users on the ARDD network tag the content item. The presentation of content within the “Me” feed can ordered in one of two ways, firstly, by ranking the total number of tags, and secondly by time, whereby the recently tagged content from that user is displayed highest on the “Me” page.

In summary, as content items such as the content item 301 are tagged by various members of the ARDD network 210, the “Best” feed 312 is continuously updated to show tagged content items in order of their popularity. Furthermore, for each member of the ARDD network 210, their personal “Friends” feed 313 is populated with content items which are time-stamped and ranked according to the most recently posted item. Finally, for each member of the ARDD network 210 a personal “Me” feed 314 is populated with the content items which that particular member has tagged, and those content items are continuously ranked and ordered by the ARDD server 209 according either (i) to the popularity of the posted content items among the friends of the member of the ARDD network 210 in question, or alternately (ii) according to the popularity of the posted content items among the entire population of members of the ARDD network 210.

In addition to the above-noted operations, when the device 201 tags the content item 301 the tagged content item is communicated, as depicted by a dotted arrow 302, to other social networks, such as the network 218. Thus, for example, when the device 201 tags the content item 301, the content item 301 is communicated to the network 218 and shows up in a feed 318, as depicted by a hashed rectangle 319, which is associated with the device 201′ in the role of a member of the network 218. This presupposes that the user (not shown) of the device 1a (i.e. 201) is a member of both the ARDD network 210 and the network 218.

Accordingly, the “tagging” (ie the “Clapping”) operation which members of the ARDD network 210 perform are reflected both by population of the feeds 312, 313, and 314, and by communication of the clapped content items to feeds such as 318 in other networks such as the network 218. The Clapped content lands on the profile page of the user on these other networks, such as network 218, as though the user had provided a post of “status update”'s within that network, sharing that piece of content to the users' friends within that network (depending on how that network posts content to friends). In this instance, the iOS share extension is one method in which users can select other networks for a piece of content to be shared to. Additionally, when a user tags content within the ARDD application, they are presented with the option of sharing that piece of content to other social networks, in this way they are not sharing the content to other networks via the share extension, but rather a series of pop-up options to share, from within the ARDD application.

Another capability of the ARDD arrangement is to enable content items tagged in other networks such as the network 218 to be communicated to one or more of the feeds 312, 313, 314 in the ARDD network 210. For example, when a user “Hearts” content on Instagram or “Shares” content from Facebook, or posts content to Facebook, Twitter or Instagram, that piece of content is automatically brought into the “Keeps” feed (alternately referred to as the “Pending” feed 304). Thus, for example, when the device 201′ tags as depicted by a dashed arrow 316 a content item 317 from within the social network 218, this is communicated, as depicted by a dotted arrow 315, to a “Keeps” feed 304 in the ARDD network 210 (described hereinafter in more detail with reference to FIG. 8). In one ARDD arrangement, the “Keeps” feed 304 is presented in the form shown in FIG. 13A on a display of the user device 201. The “Keeps” feed 304 is also designated with the reference “1 a” to indicate that the feed 304 is associated with the device 201. A content item remains in the “Keeps” feed 304 until the user of the device 201 tags or claps the content item in the “Keeps” feed 304. Once the item has been accepted in this manner, that item can be inserted into the feeds 312, 313 and 314, and then processed in the normal manner in which content items that are designated from within the ARDD network 210 (as depicted by the arrow 303) are processed The user has the option to swipe and delete content from within their “Keeps” feed, deleting the content from the user's ARDD application.

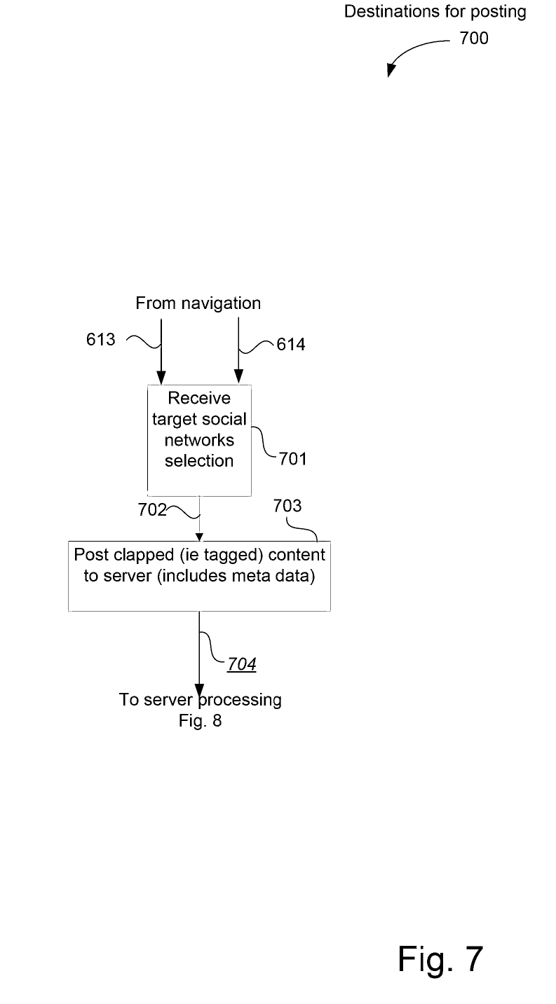

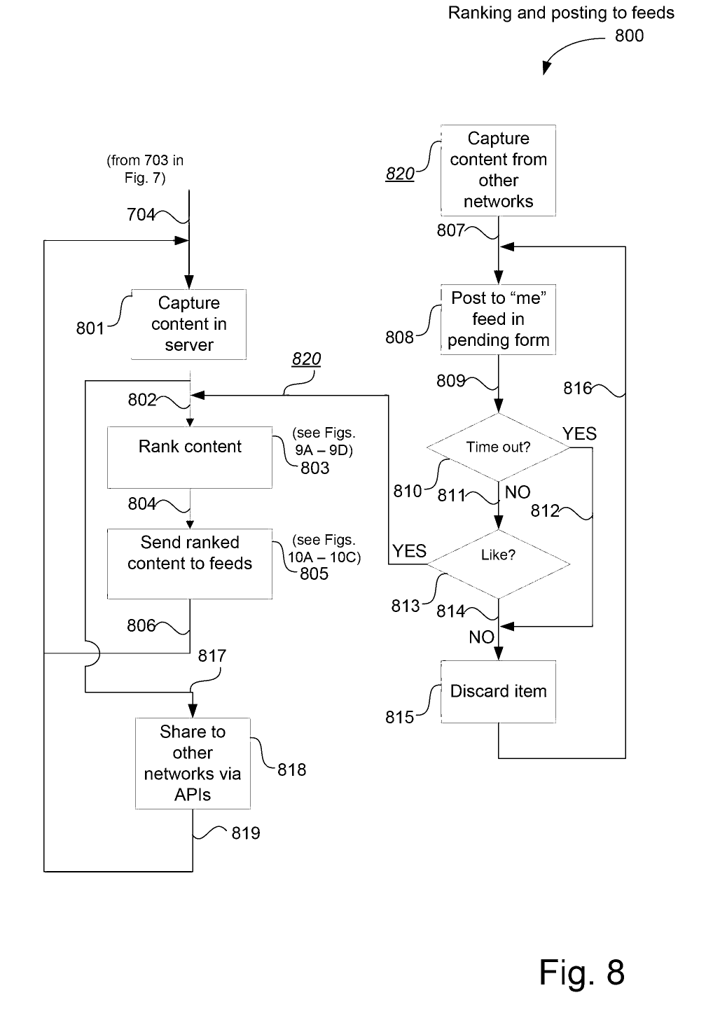

Accordingly, the ARDD arrangements offer at least the following menu of capabilities:
The device 201 can tag a content item from within the ARDD network 210, in which event the tagged content item is inserted into the feeds 312, 313, 314 and displayed and processed as previously described;
The device 201 can tag a content item from within the ARDD network 210, in which event the tagged content item is communicated to other networks such as the network 218 (provided that those other networks are selected by the user in question in the step 701 in FIG. 7); and
The device 201 can tag a content item from within another network such as 218, in which event the tagged content item is inserted into the “Keeps” feed 304 in the ARDD network 210, and if the user in question accepts the tagged item then the tagged content item is inserted into the feeds 312, 313, 314 and displayed and processed as previously described;

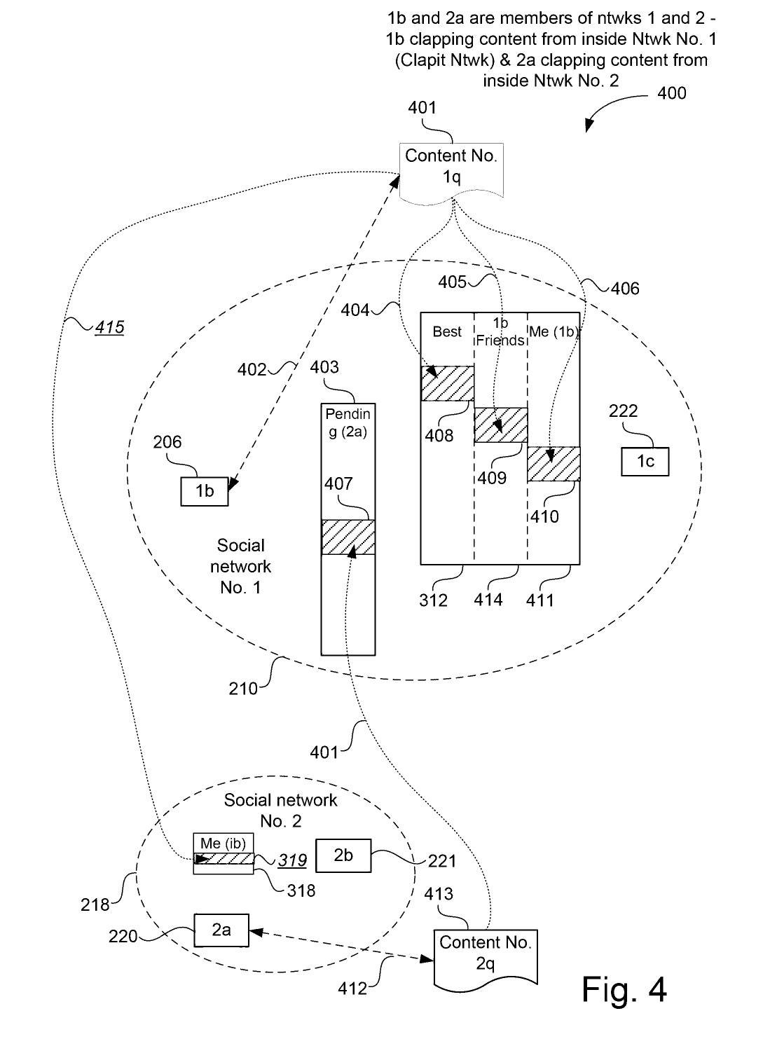

FIG. 4 illustrates another example similar to that shown in FIG. 3. FIG. 4 depicts a situation in which the device 1B (i.e., 206) and 2A (i.e., 220) are both members of both the ARDD network 210 and the social network number 2 (ie 218). The device 206 tags (ie Claps), as depicted by a dashed arrow 402, content from within the ARDD network 210, and the device 220 tags content from within the network 218.

The device 206 thus tags the content item 401 as depicted by the dashed arrow 402, this tagging operation taking place with the device 206 being within the ARDD network 210. The tagging operation 402 causes the content item 401 to be inserted into the “Best” feed 312, a “Friends” feed 414 associated with the device 206, and a “Me” feed 411 associated with the device 206, as depicted dotted arrows 404, 405, 406 respectively. The inserted content items are depicted by respective hashed rectangles 408, 409 and 410. The operation of the aforementioned feeds is similar to that described in relation to the feeds 312, 313 and 314 in FIG. 3. The tagging operation 402 also causes the content item 401 to be communicated, as depicted by a dotted arrow 415, to a feed 318, as depicted by a hashed rectangle 319, in the other social network number 2 (i.e., 218). This communication is effected by an automated post, with image content taken from the post, and a brief description of the content, and/or text or video content, limited in character and with a unique content title, which can be modified by the user. This content is shared on another social network with an automated description, for example “this item has just been clapped by XYZ User, to view it click {HERE} (Live URL)”.

The device 2a (i.e., 220) tags another content item 413, as depicted by a dashed arrow 412, from within the network 218. The tagging operation 412 causes the content item 413 to be communicated, as depicted by a dotted arrow 401, to a “Pending” feed 403, which is associated with the device 220 as a member of the ARDD network 210. The content item 413 depicted by a hashed rectangle 407, remains in the “pending” feed 403 until the user 2a (ie 220) accepts the content item 407 from within the ARDD network 210. When this occurs the content item 407 is inserted into the “Best” feed 312, as well as into a “Friend” feed and a “Me” feed that are associated with the user of the device 2 as a member of the ARDD network 210. It is noted that the “Friend” feed 414 and the “Me” feed 411 are associated with the user of the device 1b (ie 206) and not the user of the device 2a (ie 220).

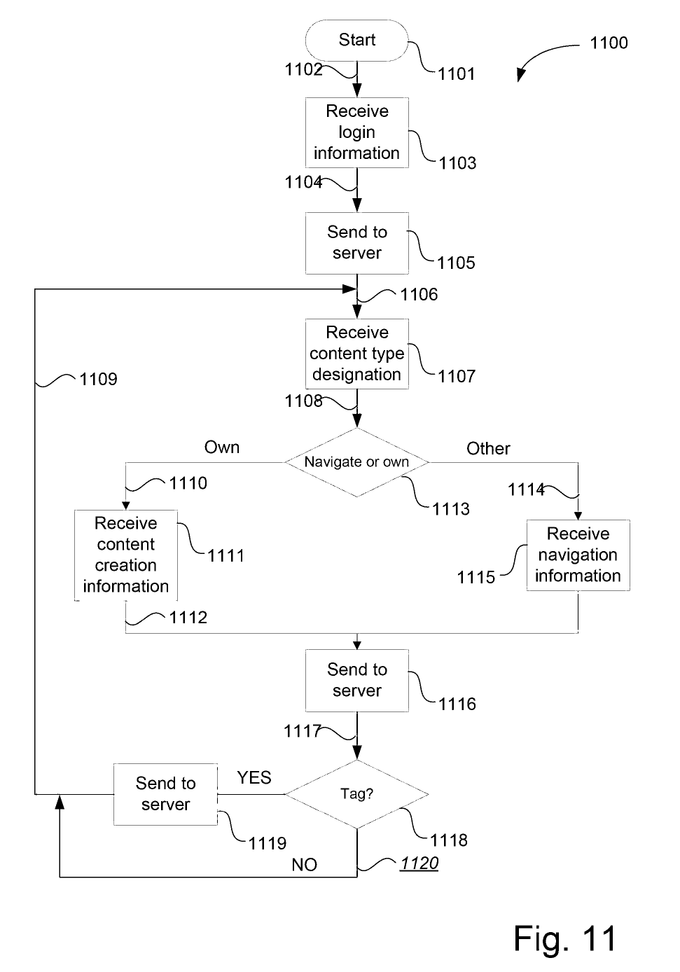

FIG. 11 is a flowchart for an example process performed by the mobile device 201 in order to practice the ARDD arrangement. The process 1100 commences with a start step 1101 after which in a step 1103 the mobile device 201, executing relevant modules (such as 225) of the ARDD software application suite 205, receives login information provided by the user of the mobile device 201 who wishes to login to the ARDD network 210. The noted user has previously registered with the ARDD server 209. Control follows an arrow 1104 from the step 1103 to a step 1105 in which the device 201 forwards the login information to the ARDD server 209.

Thereafter, in a step 1107 the mobile device 201 receives designation information from the user indicating whether the user wishes to navigate to content over the Internet using a web browser, for example, or wishes to create their own content. If the received designation relates to creation of the users own content, then control follows an “Own” arrow 1110 to a step 1111 in which the mobile device 201 receives content creation information from the user via a user interface device on the mobile device 201 (not shown). One “Own” content example is when the user takes a photo using an inbuilt camera in the device 201. If the user device 201 is a smart phone, then user interface facilities are typically provided by means of a touch screen on the mobile device 201. If, on the other hand, the user device 201 is a tablet or other form of computing device, then keyboards, pointing devices, touch screens and other mechanisms are generally available for receiving user information. Control then follows an arrow 1112 from the step 1111 to a step 1116 in which the device 201 sends the content information to the ARDD server 209.

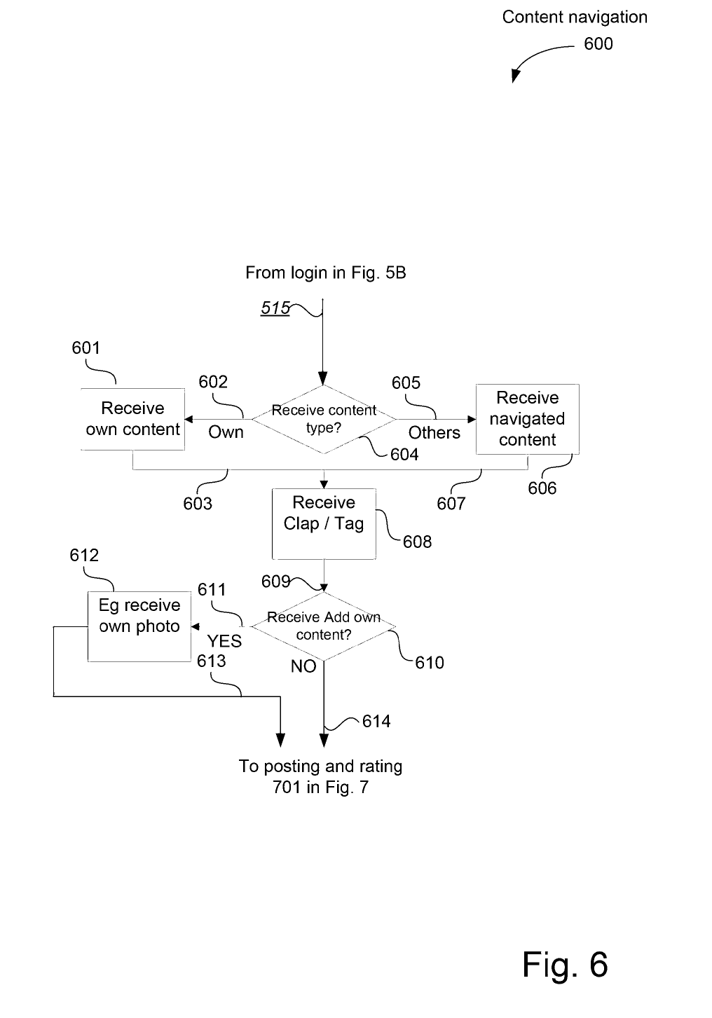

Returning to the step 1113, if the device 201 receives an indication that other information is desired by the user, then control follows an “Other” arrow 1114 to a step 1115 in which the user device 201 receives navigation information from the user typically relating to navigation commands for a web browser running on the device 201. Once the user has navigated to a desired piece of content, control passes from the step 1115 to a step 1116 in which the device 201 sends the content to the ARDD server 209. The steps 1111 and 1115 relate to content received respectively by the ARDD server 209 in steps 601 and 606 in FIG. 6.

Control then follows an arrow 1117 from the step 1116 to a step 1118 in which the device 201 determines if a tag (ie a Clap) command, such as is depicted by the dashed arrow 303 in FIG. 3, is received. If this is the case, then the device 201 sends the tag indication to the server in a following step 1119, after which control follows an arrow 1109 from the step 1119 back to the step 1107. The tag information sent by the step 1119 by the device 201 is received at the step 608 in FIG. 6 by the ARDD server 209.

Returning to the step 1118, if a tag indication is not received by the device 201 then control follows an arrow 1120 from the step 1118 back to the step 1107.

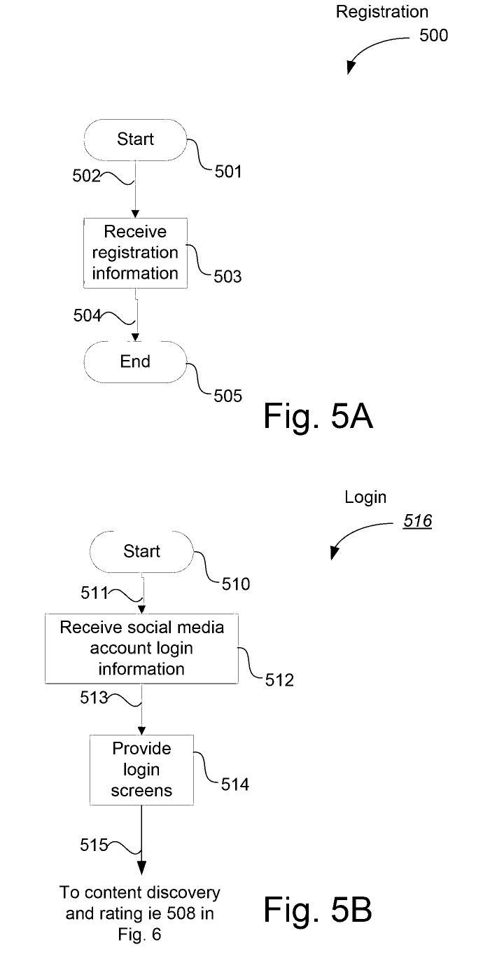

FIGS. 5A and 5B show examples of registration and login processes for a ARDD arrangement from the perspective of the ARDD server 209.

FIG. 5A is a flowchart of an example process 500 by which a user wishing to become a member of ARDD network 210 registers. The process 500 commences with a start step 501, and control then follows an arrow 502 to a registration step 503. In one ARDD arrangement, a GUI depicted in FIG. 12A is presented on a display of the user device 201 when a user of that device requests registration. In the step 503 the ARDD server 209 receives registration information from the user who wishes to join the ARDD network 210. The registration information typically includes the user's real name, a selected user name by which they will be known by other members of the ARDD network 210, a password to provide them access to the ARDD network, and other optional information such as a photograph to use with their profile. The registration information can also include information on other social networks of which the user is a member, so that tagged content can be communicated to and/or from such networks, as depicted respectively by dotted arrows 302 and 315 in FIG. 3 for example. In one ARDD arrangement, a GUI depicted in FIG. 12B is presented on a display of the user device 201 when a user of that device provides information on the other social networks to which they belong. Control then follows an arrow 504 to a step 505 where the process 500 terminates. In some ARDD arrangements, at least some of the registration information can be imported from another network such as the social network number 2 (ie 218) if the user is a member of that network.

FIG. 5B is a flow chart depicting an example of a process 516 by which a registered ARDD network user logs on to the ARDD network 210 after registering according to the process 500 in FIG. 5A. The process 516 commences with a start step 510, and after following an arrow 511 in a step 512 the ARDD server 209 receives login information from the user, typically being the user's login name and password. Control then follows an arrow 513 to a step 514 in which the ARDD server 209 performs a login routine which creates the various graphical user interfaces (GUIs) associated with the ARDD network 210 and displays these GUIs on a display screen (not shown) on the device 201. Control then follows an arrow 515 to a content discovery and rating process depicted in FIG. 6.

The ARDD server 209 receives information from the user in the steps 503 and 512, where the information is provided by the user by means of user interface mechanisms on the user device 201.

FIG. 6 is a flow chart for an example content navigation and tagging process 600 for a ARDD arrangement. The process 600 depicts how a member of the ARDD network navigates to, or alternatively creates, content items such as the item 301 in FIG. 3, and performs the tagging operation depicted by the dashed arrow 303 in FIG. 3.

The process 600 commences with the arrow 515 from FIG. 5B after which in a decision step 604, the ARDD server 209 receives information from the user in question via their associated user device 201 indicating that the user wishes either to navigate over the Internet to a particular piece of content, or alternatively wishes to generate their own content. If the server 209 receives an indication that the user wishes to navigate to content of interest, then control follows an “Others” arrow 605 to a step 606 in which the ARDD server 209 receives content such as the content item 301 from the mobile device 201, the content reflecting a web page to which the user navigated using a web browser for example. The navigation operation is typically performed using a Web browser (not shown) running on the mobile device 201.

The process 600 then follows an arrow 607 to a step 608. Returning to the decision step 604, if the ARDD server 209 receives an indication from the device 201 that the user wishes to generate their own content, e.g., by taking a photograph using an inbuilt camera device on the mobile device 201, then the process 600 follows an arrow 602 to a step 601. In the step 601 the ARDD server 209 receives content (eg the aforementioned image) generated by the user of the device 201. The process then follows an arrow 603 to the step 608.

In the step 608 the ARDD server 609 receives an indication from the device 201 as to whether the user has tagged the content item in question e.g., the content item 301.

After receiving the tag indication in the step 608, the process 600 follows an arrow 609 to a decision step 610 in which the ARDD server 209 receives an indication from the device 201 as to whether the associated user wishes to add their own content to the tagged content 301. If this is the case, then the process 600 follows a YES arrow 611 to a step 612 in which the ARDD 209 receives the personal content that the user wishes to add to the tagged content 301. This personal comment can take the form a text comment and/or an image (e.g., the user's own picture). The process 600 then follows an arrow 613 to a step 701 in FIG. 7. Returning to the decision step 610, if the ARDD server 209 receives an indication that the user does not wish to add any personal content to the tagged content 301 then the process 600 follows an arrow 614 to the step 701 in FIG. 7

FIG. 7 shows a flow chart of one example of a process 700 used by the ARDD server 209 to post tagged content to feeds in the ARDD network. The process 700 is entered as depicted by arrows 613 and 614 from FIG. 6, and in the step 701 the ARDD server 209 receives the tagged content 301, possibly also including the additional user information generated in the step 612 and other associated meta-data such as the web address of the tagged content and the type of content (e.g. Video content or Photo content). The Metadata is only collected when content is initially imported into the Clapit database 202. In the following step 703 the ARDD server 209 posts the tagged content 301 to the various feeds 312, 313 and 314 as previously described in relation to FIG. 3. Control then follows an arrow 704 to FIG. 8.

FIG. 8 is a flow chart for one example of a process 800 in which the ARDD server 209 ranks tagged content according to scores assigned to each item as previously described in regards to FIGS. 2 and 3, sends the ranked content items to various feeds in the ARDD network, and receives tagged content from other networks, as depicted by the dotted arrow 315 in FIG. 3, for example, for processing and possible posting to the feeds in the ARDD network. The process, 800 is entered from FIG. 7 as depicted by the arrow 704, after which in the step 801 the ARDD server 209 captures the content 301 that has been tagged as depicted by the dashed arrow 303 and communicated by the step 703. In a following step 803, described hereinafter in more detail in regard to FIGS. 9A-9D, the ARDD server 209 ranks the captured content in accordance with scores that are dependent upon how many members of the ARDD network 210 have tagged the particular content in question. In a following step 805, described hereinafter in more detail in regards to FIGS. 10A-10C the ARDD server 209 posts the ranked content to the feeds 312, 313, and 314, as previously described in regard to FIGS. 2 and 3. The process 800 then follows an arrow 806 back to the step 801.

Returning to the step 801, after ARDD server 209 has captured the tagged content, control also follows an arrow 817 to a step 818 in which the ARDD server 209 posts the captured tagged content to other social networks of which the user in question is a member, as depicted by the dotted arrow 302 in FIG. 3, for example. Control then follows an arrow 819 from the step 818 to the step 801. The user, having tagged the content, will be taken to a screen that contain toggles to allow a user to select which social network the content item will be shared to. The user can select whether to send this content to none, one more of these networks. Once the user has selected which network they are sending the content to, they confirm their command by pressing the clap button, and the content is then automatically posted to the profile or home page of that user, on the selected networks. E.g a post will occur on the users' Facebook and Twitter accounts, with an image of the content and/or text, and an automatically generated title “This item has just been share by user XYZ and Clapit”

The steps 801, 803, 805 and 818 relate to content that is tagged from within the ARDD network 210. As previously described in relation to FIG. 3, for example, the ARDD arrangement also processes and presents content that is tagged from within other social networks such as the network 218. In this regard, the process 800 commences with a step 820 in which ARDD server 209 captures content from other networks, as depicted for example follow the dotted arrow 315 in FIG. 3. The user will, for example, be viewing content within a web browser or mobile application, for example photo album content, mobile browser application (e.g. Safari), or other mobile application (e.g. Buzzfeed, Reddit, iTunes application, Podcast application etc). If the user wishes to tag a piece of content, the user pulls up the “Share” Menu on iOS, then selects the Clapit option (this referring to the Clapit button which effects the operations 315 and 401 in FIG. 3 and FIG. 4 respectively). Once the Clapit application has been selected, the user is taken to a screen to centre and crop the content, change the content title and choose which other social networks the content is sent to. Once the networks and title have been selected, a (Clap) button is pressed again and the content is shared to the Clapit app (ie the ARDD network 210) (either to the “keeps” feed 304 or the other feeds 312, 313, 314) and to the selected social networks. The process is completed via the Clapit server 209 sending a request to the Facebook API containing information about the Clapit content 301. The social network 218 (e.g Facebook, Twitter etc) uses that information to create a post.

In a following step 808 ARDD server 209 posts the content 317 that has been tagged in the network 218 to the “Keeps” feed 304 (also referred to as the “Pending” feed) in the ARDD network 210. Although the “Keeps” feed 304 is shown as a distinct feed in the example depicted in FIG. 3, other arrangements can equally be used for the “Keeps” feed in the ARDD arrangements. Thus, for example, the tagged content 317 can be posted to the “Best” feed 312. Returning to the step 808, once the tagged content 317 has been posted to the “Keeps” feed 304 control follows an arrow 809 to a decision step 810. If the user indicates that he or she likes the pending content item 308, then control follows a YES arrow from the step 813 to the step 803. If, however, in the decision step 813 the ARDD server 209 receives a “dismiss or delete content option occurs, removing the content from the app” indication from the user of the device 201, then control follows a NO arrow 814 to the step 815 in which the ARDD server 209 discards the item in question.

FIGS. 9A-9C show how tagged content can be buffered, aged, and scored in a ARDD arrangement. The figures illustrate flow charts for example process fragments which, in aggregate, perform the ranking function performed by the step 803 in FIG. 8.

FIG. 9A is concerned with storing the tagged content item 301 in a buffer. The buffer can be implemented in the memory 106 in the ARDD server 209. In a step 901 the ARDD server 209 receives the tagged content item 301. In a following step 904 the ARDD server 209 stores the received tagged item in the buffer together with a time stamp (referred to as t₀) indicating when the content item was initially tagged, a parameter reflecting a permitted age of content items in the buffer (represented by a parameter t₁), a source ID for the content item (this typically being an IP address), and a tag score for the received tagged content item. In one ARDD arrangement, the parameters referred to as t₀ and t₁ are stored in absolute date/time format, in order to include absolute information such as “Feb, 4, 2016, 1418, 21 seconds”. Source information for content is gathered from the API of the application that the content is coming from, if from the social network used to register into the Clapit application and/or from other social networks which have been linked to Clapit. Control then follows an arrow 903 back to the step 901 which processes the next tagged content item.

FIG. 9B is concerned with aging contents of the buffer referred to in FIG. 9A. In one ARDD arrangement, t₀ and t₁ have been stored in absolute units and the comparison process in the step 911 can be performed by comparing a current time (determined using a real-time clock) to t₀+t₁. In a step 910, the ARDD server 209 checks the contents of every register in the buffer, and determines for each buffer entry whether the elapsed time, as measured using a real-time clock, is greater than t₀+t₁ for the buffer entry in question. Control then follows an arrow 912 to a step 913 in which the ARDD server 209 purges all buffer items for which the elapsed time, as measured using a real-time clock, is greater than t₀+t₁ for the buffer entry in question. Control then follows an arrow 913 back to the step 911 after a delay which reflects a desired period for the aging process. The effect of the process in FIG. 9B is to periodically remove all entries in the buffer whose age exceeds a predetermined threshold. In some ARDD arrangements other aging methods may be used. Content that has had no engagement by any user for a pre-determined period of time, such as having received no claps, no reactions for a period (e.g. 3 hours) will be automatically removed from the feed. Data will remain in the database, however no user will see that content in the Best or Friend Feed, though will remain on the Me page of the user who posted the content to Clapit.

FIG. 9C is concerned with tracking and updating the tag score for each tagged content item stored in the buffer. In a step 920 the ARDD server 209 detects a tagging operation such as 303 in which the device 201 tags the content item 301. In a following step 923 the ARDD server 209 identifies the content item 301 being tagged, by comparing the IP address of the content item being tagged to IP addresses of content items stored in the buffer as described in relation to FIG. 9A. In a following step 925 the ARDD server 209 updates the score counter for the identified item, thereby ensuring that tag scores for items stored in the buffer are updated on a continuous basis as content items which are already stored in the buffer are tagged additional times by the members of the ARDD network.

FIGS. 10A-10C show how tagged content can be filtered, ranked and displayed in various feeds in a ARDD arrangement. The figures relate to the step 805 in FIG. 8 in which the ARDD server 209 sends ranked content from the buffer to the feeds 312, 313 and 314 in FIG. 3, for example.

FIG. 10A is a flow chart for an example process for generating the “Best” feed 312. In a first step 902, the ARDD server 209 determines, using a “t₄ timer”, whether an elapsed time exceeds a predetermined threshold t₄. If this is not the case, the control follows a NO arrow 901 back to the step 902. If, however, the elapsed time does exceed the above-noted threshold, then control follows a YES arrow 903 to a step 905. In the step 905 the ARDD server 209 sorts the buffer items that were stored in the process of FIG. 9A, into ranked order according to their tag scores. The ARDD server 209 also loads the ranked items into the “Best” feed 312. In a following step 907 the ARDD server 209 resets the “t₄ timer”, and control follows an arrow 904 back to the step 902. The effect of the process of FIG. 10A is to periodically sort the buffer items into ranked order and once the sorting into ranked order has been performed, to reload the contents of the “Best” feed 312. The “Best” feed 312 is thus dynamically updated on a periodic basis dependent upon the parameter t₄ in order to reflect the latest tag scores, which in turn reflect the latest popularity scores for the various items in the feed 312. There is typically only one “best” feed 312 in the ARDD network 210, and accordingly the process of FIG. 10A is only performed for the ARDD network as a whole.

FIG. 10B is concerned with generating the “Friend” feed 313. In a step 911, the ARDD server 209 determines if an elapsed time as measured by a “t₅ timer” exceeds a predetermined threshold t₅. If this is not the case, then control follows a NO arrow 910 back to the step 911. If, on the other hand, the threshold has been exceeded, then control follows a YES arrow 912 from the step 911 to a step 914. In the step 914, the ARDD server 209 identifies those items in the buffer than have been tagged by a particular user and friends of that user. In a following step 916 the ARDD server 209 sorts buffer items identified by the step 914 into ranked order, and loads the ranked list into the “Friends” feed 313. In a following step 918, the ARDD server 209 resets the “t₅ timer” and control follows an arrow 913 back to the step 911. The effect of the process in FIG. 10B is to generate a distinct “Friends” feed for every member of the ARDD network 210. An instance of the process in FIG. 10B is performed for each member of the ARDD network 210, and accordingly if there are N members in the ARDD network 210 there are N instances of the process in FIG. 10B.

FIG. 10C is concerned with generating the “Me” feed 314. In a step 921 the ARDD server 209 determines if a “t₆ timer” exceeds a predetermined threshold t₆. If this is not the case, then control follows an NO arrow back to the step 921. If, on the other hand, the threshold has been exceeded, then control follows a YES arrow 923 to a step 924. In the step 924 the ARDD server 209 identifies all items in the buffer which have been tagged by the user in question. In the following step 926 the ARDD server 209 sorts the identified items into ranked order, and loads the sorted list into the “Me” feed for the user in question. In a following step 928 the ARDD server 209 resets the “t₆ timer”, and control follows an arrow 922 back to the step 921. There are as many “Me” feeds as there are members of the ARDD network 210, and thus if there are P members of the ARDD network 210, then there are typically P instances of the process in FIG. 10C.

### INDUSTRIAL APPLICABILITY

The arrangements described are applicable to the computer and data processing industries and particularly for the electronic communication industries.

The foregoing describes only some embodiments of the present invention, and modifications and/or changes can be made thereto without departing from the scope and spirit of the invention, the embodiments being illustrative and not restrictive.

1. A computer implemented method of communicating, between computers in a first group of computers communicating over a communication network using a first server computer executing a first social network software application, tagged content items and scores determined for the tagged content items, the method comprising the steps of:
tagging, by a first computer belonging to the first group, a content item that is accessible over the communication network;
determining, by the first server, a score for the content item dependent upon a number of times the content item is tagged by other computers belonging to the first group;
repeating the tagging and determining steps for a plurality of content items that are tagged by a computer belonging to the first group; and
arranging, depending upon the determined scores, the plurality of content items and their associated scores in a first list that is accessible by the first group of computers.

2. A method according to claim 1, further comprising the steps of:
selecting content items in the first list that have been tagged by a computer in a first sub-group in the first group of computers, the first sub-group comprising computers of the first group of computers whose users have designated each other as friends; and
arranging, depending upon the determined scores, the selected content items in a second list that is accessible by the first sub-group of computers.

3. A method according to claim 1, further comprising the steps of:
identifying content items in the first list that have been tagged by the first computer in the first group of computers; and
arranging, depending upon the determined scores, the identified content items in a third list that is accessible by the first computer in the group of computers.

4. A method according to claim 1, wherein the first group of computers is configured to communicate with a second group of computers over the communication network; the second group of computers communicating over the communication network using a second server computer executing a second social network software application; and the first computer is a member of the second group of computers; and the method comprising the further steps of:
communicating the content item tagged by the first computer in the first group of computers to the second server.

5. A method according to claim 3, wherein the first group of computers is configured to communicate with a second group of computers over the communication network; the second group of computers communicating over the communication network using a second server computer executing a second social network software application; and the first computer is a member of the second group of computers; and the method comprising the further steps of:
tagging, by the first computer as a member of the second group of computers, a content item that is accessible over the communication network; and
communicating, by the second server, the content item tagged by the first computer in the second group of computers to the first server.

6. A method according to claim 5, comprising the further steps of:
arranging the communicated content item in the third list in pending format.

7. A computer implemented method of communicating, between computers in a first group of computers communicating over a communication network using a first server computer executing a first social network software application, tagged content items and scores determined for the tagged content items, the method comprising the steps of:
receiving by the first server a tagging indication from a first computer belonging to the first group, the tagging indication indicating that the first computer has tagged a content item that is accessible over the communication network;
determining, by the first server, a score for the content item dependent upon a number of times the content item is tagged by other computers belonging to the first group;
repeating by the first server the receiving and determining steps for a plurality of content items that are tagged by computers belonging to the first group; and
arranging by the first server, depending upon the determined scores, the plurality of content items and their associated scores in a first list that is accessible by the first group of computers.

8. A method according to claim 7, further comprising the steps of:
selecting by the first server content items in the first list that have been tagged by a computer in a first sub-group in the first group of computers, the first sub-group comprising computers of the first group of computers whose users have designated each other as friends; and
arranging, by the first server depending upon the determined scores, the selected content items in a second list that is accessible by the first sub-group of computers.

9. A method according to claim 7, further comprising the steps of:
identifying by the first server content items in the first list that have been tagged by the first computer in the first group of computers; and
arranging by the first server, depending upon the determined scores, the identified content items in a third list that is accessible by the first computer in the group of computers.

10. A method according to claim 7, wherein the first group of computers is configured to communicate with a second group of computers over the communication network; the second group of computers communicating over the communication network using a second server computer executing a second social network software application; and the first computer is a member of the second group of computers; and the method comprising the further steps of:
communicating by the first server the content item tagged by the first computer in the first group of computers to the second server.

11. A method according to claim 9, wherein the first group of computers is configured to communicate with a second group of computers over the communication network; the second group of computers communicating over the communication network using a second server computer executing a second social network software application; and the first computer is a member of the second group of computers; and the method comprising the further steps of:
receiving by the first server a tagging indication from a first computer as a member of the second group of computers, the tagging indication indicating that the first computer has tagged a content item that is accessible over the communication network; and
receiving by the first server from the second server, the content item tagged by the first computer in the second group of computers.

12. A system for communicating, between computers in a first group of computers communicating over a communication network using a first server computer executing a first social network software application, tagged content items and scores determined for the tagged content items, the system comprising:
the first server and the first group of computers each comprising at least one processor, and the communication network; and
the first social network application comprising software executable first application software modules for directing respective processors to perform a method comprising the steps of:
tagging, by a first computer belonging to the first group, a content item that is accessible over the communication network;
determining, by the first server, a score for the content item dependent upon a number of times the content item is tagged by other computers belonging to the first group;
repeating the tagging and determining steps for a plurality of content items that are tagged by a computer belonging to the first group; and
arranging, depending upon the determined scores, the plurality of content items and their associated scores in a first list that is accessible by the first group of computers.

13. A first server computer for performing a computer implemented method of communicating, between computers in a first group of computers communicating over a communication network using the first server computer executing a first social network software application module, tagged content items and scores determined for the tagged content items, the server comprising:
a processor; and
a memory device storing the first social network software application module for directing the processor to perform a method comprising the steps of:
receiving by the first server a tagging indication from a first computer belonging to the first group, the tagging indication indicating that the first computer has tagged a content item that is accessible over the communication network;
determining, by the first server, a score for the content item dependent upon a number of times the content item is tagged by other computers belonging to the first group;
repeating by the first server the receiving and determining steps for a plurality of content items that are tagged by a computer belonging to the first group; and
arranging by the first server, depending upon the determined scores, the plurality of content items and their associated scores in a first list that is accessible by the first group of computers.

14. A computer readable non-transitory storage medium storing a first social network software application module for directing a first server computer to perform a computer implemented method of communicating, between computers in a first group of computers communicating over a communication network using the first server computer, tagged content items and scores determined for the tagged content items, the program comprising:
computer executable code for receiving by the first server a tagging indication from a first computer belonging to the first group, the tagging indication indicating that the first computer has tagged a content item that is accessible over the communication network;
computer executable code for determining, by the first server, a score for the content item dependent upon a number of times the content item is tagged by other computers belonging to the first group;
computer executable code for repeating by the first server the receiving and determining steps for a plurality of content items that are tagged by a computer belonging to the first group; and
computer executable code for arranging by the first server, depending upon the determined scores, the plurality of content items and their associated scores in a first list that is accessible by the first group of computers.
